(19) United States
(12) Patent Application Publication
(10) Pub. No.: US 2016/0218864 A1
(43) Pub. Date: Jul. 28, 2016

(54) ENCRYPTION DEVICE, ENCRYPTION METHOD, AND DELIVERY SYSTEM

(71) Applicant: PANASONIC INTELLECTUAL PROPERTY MANAGEMENT CO., LTD., Osaka (JP)

(72) Inventors: Kouji Mutou, Fukuoka (JP); Masakatsu Matsuo, Fukuoka (JP); Katsunori Kogata, Saitama (JP)

(73) Assignee: PANASONIC INTELLECTUAL PROPERTY MANAGEMENT CO., LTD., Osaka (JP)

(21) Appl. No.: 15/001,565

(22) Filed: Jan. 20, 2016

(30) Foreign Application Priority Data
Jan. 26, 2015 (JP) 2015-012566

(51) Int. Cl. H04L 9/08; G06F 21/60

(52) U.S. Cl. CPC H04L 9/0822; G06F 21/602; H04L 2209/24

(57) ABSTRACT

An encryption device includes a sharer that shares data to first data and second data with different sizes using secret sharing, a data encryptor that encrypts the second data with the size smaller than the first data using a common key corresponding to a common key encryption scheme, a combiner that combines the first data and the second data encrypted by the data encryptor, and a transmitter that transmits the encrypted data combined by the combiner to an external device. The encryption device suppresses deterioration in security at the time of delivery of the data while reducing a load of an encryption process for the data to be delivered.

### BACKGROUND OF THE INVENTION

1. Field of the Invention

The present disclosure relates to an encryption device, an encryption method, and a delivery system encrypting and delivering data.

2. Description of the Related Art

For example, when video data captured by cameras or data generated by applications installed in data communication devices such as personal computers (PCs) are delivered to external devices according to user operations, the data are generally encrypted before the delivery of the data in order to prevent leakage, alternation, or the like of the data.

As a technology of the related art for encrypting data before delivery, there is a content delivery system disclosed in, for example, Japanese Patent Unexamined Publication No. 2012-142781. In the content delivery system disclosed in Japanese Patent Unexamined Publication No. 2012-142781, a content delivery device divides data of electronic content into data configuration information defining the configuration of the data body as first data and the data body as second data and encrypts the first data using a user key corresponding to a user of a terminal device. The content delivery device transmits the encrypted first data, the second data, and the user key to each terminal device. The terminal device receives such data, decrypts the encrypted first data using the user key, and combines the first data and the second data obtained through the decryption to obtain the electronic content.

The present disclosure is to provide a technology for suppressing deterioration in security at the time of delivery of data while reducing a load of an encryption process for data to be delivered.

### SUMMARY OF THE INVENTION

According to the present disclosure, there is provided an encryption device including: a sharer that shares data to first data and second data with different sizes using secret sharing; a data encryptor that encrypts the second data with the size smaller than the first data using a key corresponding to a key encryption scheme; a combiner that combines the first data and the second data encrypted by the data encryptor; and a transmitter that transmits encrypted data combined by the combiner to an external device.

According to the present disclosure, there is provided an encryption method in an encryption device. The method includes: sharing data to first data and second data with different sizes using secret sharing; encrypting the second data with the size smaller than the first data using a key corresponding to a key encryption scheme; combining the first data and the encrypted second data; and transmitting combined encrypted data to an external device.

According to the present disclosure, there is provided a delivery system in which an encryption device and a decryption device are connected. The encryption device includes a sharer that shares first data and second data with different sizes using secret sharing, a data encryptor that encrypts the second data with the size smaller than the first data using a key corresponding to a key encryption scheme, a combiner that combines the first data and the second data encrypted by the data encryptor, and a first transmitter that transmits encrypted data combined by the combiner to an decryption device. The decryption device includes a receiver that receives the encrypted data transmitted from the first transmitter, a divider that divides the encrypted data into the first data and the second data encrypted by the data encryptor, a data decryptor that decrypts the second data encrypted by the data encryptor using the key, a restorer that restores the data using the first data and the second data decrypted by the data decryptor, and an outputter that transmits the data restored by the restorer.

According to the present disclosure, it is possible to suppress deterioration in security at the time of delivery of data while reducing a load of an encryption process for data to be delivered.

### BRIEF DESCRIPTION OF DRAWINGS

FIG. 1 is a diagram illustrating an operation overview of a data transmitter according to an exemplary embodiment;

FIG. 2 is a block diagram illustrating an example of an internal configuration of each of a data transmitter and a data receiver according to the present exemplary embodiment;

FIG. 3 is a flowchart illustrating an example of a chronological operation sequence of the data transmitter according to the present exemplary embodiment;

FIG. 4 is a diagram illustrating encrypted data transmitted from the data transmitter according to the present exemplary embodiment;

FIG. 5 is a diagram illustrating an example of a processing speed ratio of a common key encryption scheme (for example, AES encryption 256 bits) to an asymmetric secret sharing;

FIG. 6 is a diagram illustrating an example of a processing time ratio of the common key encryption scheme (for example, AES encryption 256 bits) to the asymmetric secret sharing; and

FIG. 7 is a flowchart illustrating an example of a chronological operation sequence of the data receiver according to the present exemplary embodiment.

### DETAILED DESCRIPTION OF THE PREFERRED EMBODIMENTS

Hereinafter, an exemplary embodiment in which an encryption device, an encryption method, and a delivery system according to the present disclosure are specifically disclosed (hereinafter referred to the “present exemplary embodiment”) will be described with reference to the drawings. The delivery system according to the present disclosure is configured to include an encryption device encrypting and transmitting data and a decryption device receiving and decrypting the data. In the present exemplary embodiment, a data transmitter and a data receiver will be exemplified as the encryption device and the decryption data in the description. For example, the data transmitter according to the present exemplary embodiment is a PC or a camera and the data receiver according to the present exemplary embodiment is a PC.

### Operation Overview of Data Transmitter

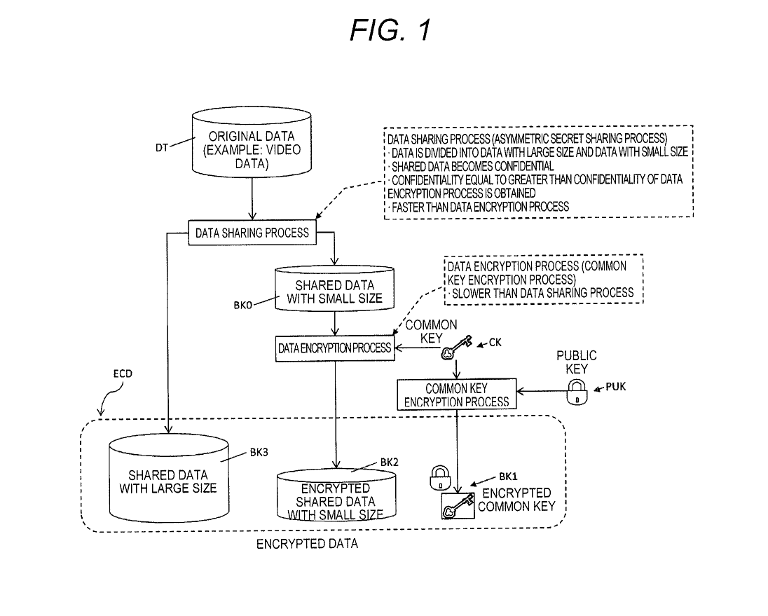

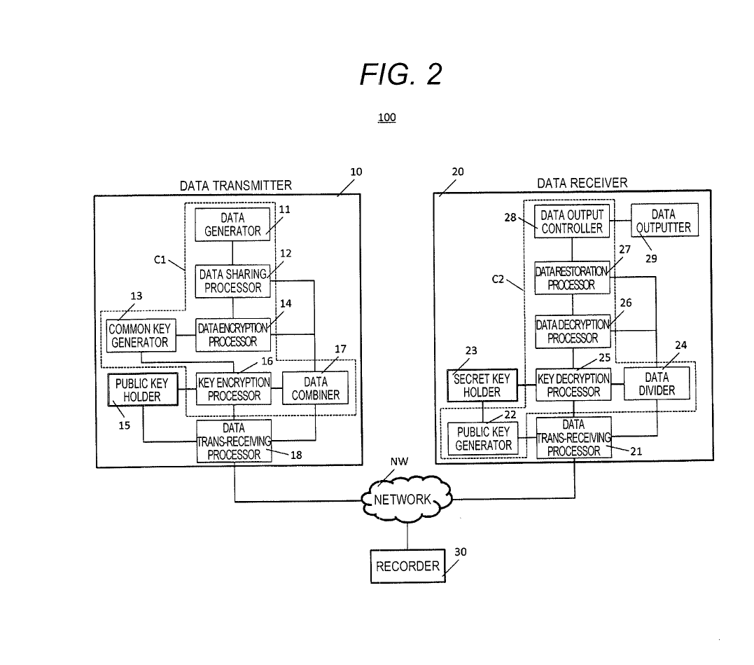

First, an operation overview of data transmitter 10 in delivery system 100 according to the present exemplary embodiment will be described with reference to FIG. 1. FIG. 1 is a diagram illustrating the operation overview of data transmitter 10 according to the present exemplary embodiment. Data transmitter 10 shares original data (for example, video data) DT to be delivered (transmitted) to data receiver 20 (see FIG. 2) to other pieces of shared data BK0 and BK3 with different data sizes through a data sharing process (for example, an asymmetric secret sharing process).

Shared data BK0 has a smaller data size than shared data BK3. Since the pieces of shared data BK0 and BK3 are generated through the asymmetric secret sharing process, original data DT is rarely analogized along, and thus becomes confidential. Further, cryptographic confidentiality of the shared data generated through the asymmetric secret sharing process is equal to or greater than cryptographic confidentiality of encrypted data generated through an encryption process. For the asymmetric secret sharing process, the details of an algorithm using exclusive OR are disclosed in, for example, Japanese Patent Unexamined Publication No. 2013-225078. Therefore, the description thereof will be omitted herein. Data transmitter 10 can perform the asymmetric secret sharing process faster than an encryption process in a key encryption scheme.

Here, a difference between the asymmetric secret sharing process and a key encryption scheme will be described in brief. The key encryption scheme is broadly classified into two schemes: a common key encryption scheme also called secret key encryption or symmetric key encryption and public key encryption scheme also called asymmetric key encryption. As the common key encryption scheme, there are an AES encryption scheme and an RC4 encryption scheme. As the public key encryption scheme, there are an RSA encryption scheme and an ElGamal encryption scheme. Encryption is performed using a key in a key encryption scheme, whereas encryption is performed through dividing into shared data in an asymmetric secret sharing scheme. Therefore, to perform decryption, encrypted data and key data are necessary in the key encryption scheme and a plurality of pieces of shared data are necessary in the asymmetric secret sharing. At this time, since the shared data generally has a larger data size than the key data and deciphering is difficult, the shared data has cryptographic confidentiality equal to or greater than cryptographic confidentiality of the encrypted data generated through the encryption process. In the following description, the key encryption scheme will be described using a common key encryption scheme (for example, an AES encryption scheme to be described below) generally used at the time of transmission of data. However, the above-described encryption scheme may be used.

Data transmitter 10 performs AES encryption on shared data BK0 with a small size using common key CK corresponding to a common key encryption scheme (for example, an AES encryption scheme) and further encrypts common key CK using public key PUK of data receiver 20 transmitted in advance from data receiver 20. In the encryption process for data (that is, shared data BK0), an encryption process of a common key encryption scheme (for example, an AES encryption scheme) is performed and is slower than a data sharing process (for example, an asymmetric secret sharing process) (that is, a processing speed is low). Data transmitter 10 generates encrypted data ECD in which encrypted common key BK1, encrypted shared data BK2 with a small size, and shared data BK3 with a large size are combined, and then transmits encrypted data ECD to data receiver 20.

In the combination of encrypted common key BK1, encrypted shared data BK2 with a small size, and shared data BK3 with a large size, a data body may not be combined and each piece of data may be associated for the combination.

### Configuration of Delivery System

Next, the system configuration of delivery system 100 according to the present exemplary embodiment will be described with reference to FIG. 2. FIG. 2 is a block diagram illustrating an example of an internal configuration of each of data transmitter 10 and data receiver 20 according to the present exemplary embodiment. In delivery system 100 illustrated in FIG. 2, data transmitter 10, data receiver 20, and recorder 30 are connected via network NW.

Data transmitter 10 illustrated in FIG. 2 is configured to include data generator 11, data sharing processor 12, common key generator 13, data encryption processor 14, public key holder 15, key encryption processor 16, data combiner 17, and data trans-receiving processor 18. Data receiver 20 illustrated in FIG. 2 is configured to include data trans-receiving processor 21, public key generator 22, secret key holder 23, data divider 24, key decryption processor 25, data decryption processor 26, data restoration processor 27, data output controller 28, and data outputter 29.

Network NW is a wireless network or a wired network. Examples of the wireless network include wireless Local Area Networks (LAN) such as Near Field Communication (NFC), Bluetooth (registered trademark), IrDA, and Wi-Fi (registered trademark), 3G, Long Term Evolution (LTE), and WiGig. Examples of the wired network include an intranet and the Internet.

In data transmitter 10, data generator 11, data sharing processor 12, common key generator 13, data encryption processor 14, key encryption processor 16, and data combiner 17 surrounded by dotted line C1 are mounted when, for example, a central processing unit (CPU), a micro processing unit (MPU), or a digital signal processor (DSP) executes data and programs regulating operations corresponding to these units. In data transmitter 10, a random access memory (RAM) operating as a work memory in the operations of these units surrounded by dotted line C1 is provided.

Similarly, in data receiver 20, public key generator 22, data divider 24, key decryption processor 25, data decryption processor 26, data restoration processor 27, and data output controller 28 surrounded by dotted line C2 are mounted when, for example, a CPU, an MPU, or a DSP executes data and programs regulating operations corresponding to these units. In data receiver 20, a RAM operating as a work memory in the operations of these units surrounded by dotted line C2 is provided.

Data generator 11 generates original data DT (for example, video data) to be delivered to data receiver 20 by data transmitter 10 and transmits original data DT to data sharing processor 12. For example, data generator 11 may be configured by a capture that captures a subject when data transmitter 10 is a camera, or may be configured by an application installed in advance in data transmitter 10.

Data sharing processor 12 which is an example of a sharer shares original data DT (for example, video data) to be delivered to data receiver 20 using a data sharing process (for example, an asymmetric secret sharing process) to share pieces of data BK0 and BK3 with different data sizes. Shared data BK3 has the data size larger than shared data BK0. Data sharing processor 12 transmits shared data BK3 with the larger data size to data combiner 17 and transmits shared data BK0 with the smaller data size to data encryption processor 14.

In the asymmetric secret sharing processing of data sharing processor 12, any sharing ratio of original data DT may be set according to a user operation. For example, when the data size of original data DT is 1 M bytes, data sharing processor 12 generates shared data BK3 with 900 k bytes and shared data BK0 with 100 k bytes. However, data sharing processor 12 may generate shared data BK3 with 600 k bytes and shared data BK0 with 400 k bytes according to a user operation.

Common key generator 13 generates a common key (for example, common key CK for AES encryption) corresponding to a common key encryption scheme (for example, an AES encryption scheme) according to a user operation on data transmitter 10 and transmits common key CK to data encryption processor 14 and key encryption processor 16.

Data encryption processor 14 which is an example of a data encryptor encrypts shared data BK0 received from data sharing processor 12 using common key CK received from common key generator 13. That is, data encryption processor 14 performs the AES encryption on shared data BK0 using common key CK. Data encryption processor 14 transmits encrypted shared data BK2 with the small size to data combiner 17.

Public key holder 15 which is an example of a key holder is configured using, for example, a hard disk or a semiconductor memory such as a flash memory and stores public key PUK of data receiver 20 transmitted from data receiver 20. Before data transmitter 10 generate encrypted data ECD (see FIG. 4), public key holder 15 already receives public key PUK of data receiver 20 from data receiver 20 and stores public key PUK. Public key PUK is data which is set by a user or is automatically assigned from data receiver 20 or the like.

Key encryption processor 16 reads public key PUK of data receiver 20 from public key holder 15 and encrypts common key CK received from common key generator 13 using public key PUK. Key encryption processor 16 transmits encrypted common key BK1 to data combiner 17.

Data combiner 17 which is an example of a combiner combines shared data BK3 with the large data size, encrypted shared data BK2 with the small data size, and encrypted common key BK1 to generate encrypted data ECD (see FIG. 4). FIG. 4 is a diagram illustrating encrypted data ECD transmitted from data transmitter 10 according to the present exemplary embodiment. Data transmitter 10 may not simultaneously transmit encrypted common key BK1 in encrypted data ECD along with the pieces of shared data BK2 and BK3 to data receiver 20, but may transmit encrypted common key BK1 to data receiver 20 at a different timing. Data combiner 17 transmits encrypted data ECD to data trans-receiving processor 18.

Data trans-receiving processor 18 which is an example of a (first) transmitter transmits encrypted data ECD or encrypted common key BK1 to data receiver 20 or recorder 30. Data trans-receiving processor 18 receives public key PUK of data receiver 20 transmitted from data receiver 20 or recorder 30 and stores public key PUK in public key holder 15.

Data trans-receiving processor 21 which is an example of a receiver receives encrypted data ECD or encrypted common key BK1 transmitted from data transmitter 10 or recorder 30, transmits encrypted data ECD to data divider 24, and transmits encrypted common key BK1 to key decryption processor 25. Data trans-receiving processor 21 which is an example of a second transmitter transmits public key PUK of data receiver 20 received from public key generator 22 to data transmitter 10 or recorder 30.

Public key generator 22 which is an example of a public key generator generates public key PUK and secret key PRK of data receiver 20 corresponding to the public key encryption scheme according to a user operation of data receiver 20, transmits public key PUK to data trans-receiving processor 21, and stores secret key PRK in secret key holder 23.

Secret key holder 23 is configured using, for example, a hard disk or a semiconductor memory such as a flash memory and stores secret key PRK of data receiver 20 received from public key generator 22.

Data divider 24 which is an example of a divider divides encrypted data ECD received from data trans-receiving processor 21 into encrypted common key BK1, encrypted shared data BK2 with the small data size, and shared data BK3 with the large data size. Data divider 24 transmits encrypted common key BK1 to key decryption processor 25, transmits encrypted shared data BK2 with the small data size to data decryption processor 26, and transmits shared data BK3 with the large data size to data restoration processor 27.

Key decryption processor 25 reads secret key PRK of data receiver 20 from secret key holder 23, decrypts encrypted common key BK1 using secret key PRK, and transmits common key CK obtained through the decryption to data decryption processor 26.

Data decryption processor 26 which is an example of a data decryptor decrypts encrypted shared data BK2 with the small data size using common key CK received from key decryption processor 25 and transmits shared data BK0 with the small data size obtained through the decryption to data restoration processor 27.

Data restoration processor 27 which is an example of a restorer restores original data DT from shared data BK0 with the small data size and shared data BK3 with the large data size using a data restoration process based on an algorithm for the same asymmetric sharing process as data sharing processor 12, and then transmits original data DT obtained through the restoration to data output controller 28.

Data output controller 28 controls processes of outputting original data DT received from data restoration processor 27 to data outputter 29 (for example, a display process on a display and an audio outputting process to a speaker) according to classification of original data DT.

Data outputter 29 which is an example of an outputter is configured to include, for example, a display, a speaker, or a combination thereof and display original data DT on the display, reproduces original data DT and outputs the audio from the speaker, or performs both of the displaying and the reproducing and outputting under the control of data output controller 28.

Recorder 30 is configured to include a storage that includes, for example, a hard disk and stores encrypted data ECD or encrypted common key BK1 transmitted from data transmitter 10 or public key PUK of data receiver 20 transmitted from data receiver 20.

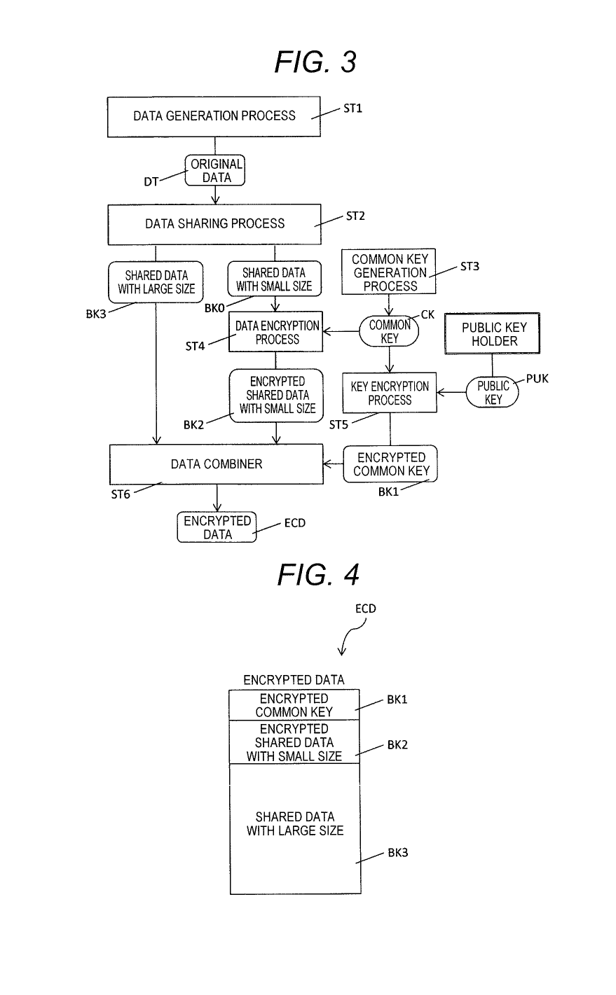

Next, an operation sequence of data transmitter 10 of delivery system 100 according to the present exemplary embodiment will be described with reference to FIG. 3. FIG. 3 is a flowchart illustrating an example of a chronological operation sequence of data transmitter 10 according to the present exemplary embodiment.

In FIG. 3, data generator 11 generates original data DT (for example, video data) to be delivered to data receiver 20 by data transmitter 10 and transmits original data DT to data sharing processor 12 (ST1).

Data sharing processor 12 shares original data DT (for example, video data) to be delivered to data receiver 20 to the pieces of shared data BK0 and BK3 with the different data sizes using the data sharing process (for example, an asymmetric secret sharing process) (ST2). Shared data BK3 has the data size larger than shared data BK0. Data sharing processor 12 transmits shared data BK3 with the large data size to data combiner 17 and transmits shared data BK0 with the small data size to data encryption processor 14.

Common key generator 13 generates the common key (for example, common key CK for AES encryption) corresponding to the common key encryption scheme (for example, an AES encryption scheme) according to a user operation on data transmitter 10 and transmits common key CK to data encryption processor 14 and key encryption processor 16 (ST3).

Data encryption processor 14 encrypts shared data BK0 received from data sharing processor 12 using common key CK received from common key generator 13 (ST4). That is, data encryption processor 14 performs the AES encryption on shared data BK0 using common key CK (ST4). Data encryption processor 14 transmits encrypted shared data BK2 with the small data size to data combiner 17.

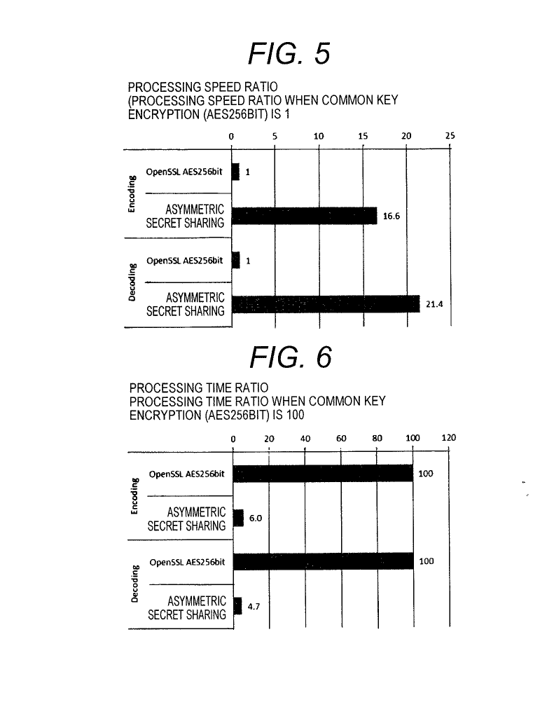

Here, a processing speed ratio or a processing time ratio of the asymmetric secret sharing process performed by data sharing processor 12 to the encryption process corresponding to the common key encryption scheme performed by data encryption processor 14 will be described with reference to FIGS. 5 and 6. FIG. 5 is a diagram illustrating an example of a processing speed ratio of a common key encryption scheme (for example, AES encryption 256 bits) to the asymmetric secret sharing. FIG. 6 is a diagram illustrating an example of a processing time ratio of the common key encryption scheme (for example, AES encryption 256 bits) to the asymmetric secret sharing.

In FIGS. 5 and 6, the examples are generated based on actually measured values under the following measurement environment. That is, in the measurement environment, a used PC is Optiplex (registered trademark) 980 made by DELL (registered trademark), an operating system (OS) is Windows (registered trademark) 7, a CPU is CORE i7 3 GHz of Intel (registered trademark), a RAM is 4 GB, a compiler is Microsoft (registered trademark) VisualStudio (registered trademark) 2005 (no optimization), and a version of “OpenSSL” which is open source software for the AES encryption is 1.0.3c (no assembler). As a measurement method, processes of AES encryption, AES decryption, asymmetric secret sharing, and restoration are performed on 100-Mbyte data on the RAM. The number of samples is 10 times and an average value of the measurement of each sample is illustrated in FIGS. 5 and 6.

As illustrated in FIG. 5, when a processing speed of the encryption process of “OpenSSL” in which common key CK for the AES encryption has 256 bits (32 bytes) is assumed to be 1, the processing speed of the asymmetric secret sharing process is 16.6 according to the ratio of the actually measurement value. That is, the processing speed of the asymmetric secret sharing is 16.6 times the processing speed of the AES encryption process using common key CK with 256 bits (32 bytes), and thus the process can be performed at a high speed.

When a processing speed of the decryption process of “OpenSSL” in which common key CK for the AES decryption has 256 bits (32 bytes) is assumed to be 1, the processing speed of the restoration process corresponding to the asymmetric secret sharing process is 21.4 according to the ratio of the actually measured value. That is, the processing speed of the restoration process corresponding to the asymmetric secret sharing is 21.4 times the processing speed of the AES decryption process using common key CK with 256 bits (32 bytes), and thus the process can be performed at a high speed.

As illustrated in FIG. 6, when a processing time of the encryption process of “OpenSSL” in which common key CK for the AES encryption has 256 bits (32 bytes) is assumed to be 100, the processing time of the asymmetric secret sharing process is 6.0 according to the ratio of the actually measurement value. That is, the processing time of the asymmetric secret sharing is 6% of the processing time of the AES encryption process using common key CK with 256 bits (32 bytes), and thus the process can be performed at a high speed.

When a processing time of the decryption process of “OpenSSL” in which common key CK for the AES decryption has 256 bits (32 bytes) is assumed to be 100, the processing time of the restoration process corresponding to the asymmetric secret sharing process is 4.7 according to the ratio of the actually measured value. That is, the processing time of the restoration process corresponding to the asymmetric secret sharing is 4.7% of the processing time of the AES decryption process using common key CK with 256 bits (32 bytes), and thus the process can be performed at a high speed.

Key encryption processor 16 reads public key PUK of data receiver 20 from public key holder 15 and encrypts common key CK received from common key generator 13 using public key PUK (ST5). Key encryption processor 16 transmits encrypted common key BK1 to data combiner 17.

Data combiner 17 combines shared data BK3 with the large data size, encrypted shared data BK2 with the small data size, and encrypted common key BK1 to generate encrypted data ECD (ST6).

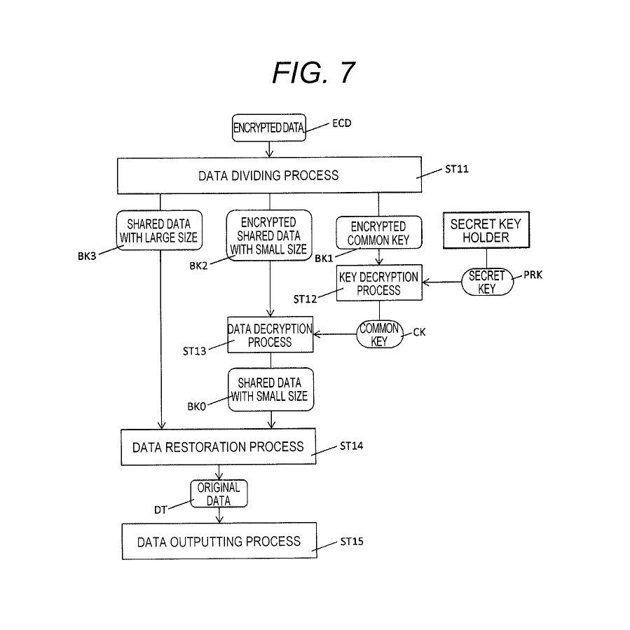

Next, an operation sequence of data receiver 20 of delivery system 100 according to the present exemplary embodiment will be described with reference to FIG. 7. FIG. 7 is a flowchart illustrating an example of a chronological operation sequence of data receiver 20 according to the present exemplary embodiment.

In FIG. 7, data trans-receiving processor 21 receives encrypted data ECD or encrypted common key BK1 transmitted from data transmitter 10 or recorder 30, transmits encrypted data ECD to data divider 24, and transmits encrypted common key BK1 to key decryption processor 25.

Data divider 24 divides encrypted data ECD received from data trans-receiving processor 21 into encrypted common key BK1, encrypted shared data BK2 with the small data size, and shared data BK3 with the large data size (ST11). Data divider 24 transmits encrypted common key BK1 to key decryption processor 25, transmits encrypted shared data BK2 with the small data size to data decryption processor 26, and transmits shared data BK3 with the large data size to data restoration processor 27.

Key decryption processor 25 reads secret key PRK of data receiver 20 from secret key holder 23, decrypts encrypted common key BK1 using secret key PRK (ST12), and transmits common key CK obtained through the decryption to data decryption processor 26.

Data decryption processor 26 decrypts encrypted shared data BK2 with the small data size using common key CK received from key decryption processor 25 (ST13) and transmits shared data BK0 with the small data size obtained through the decryption to data restoration processor 27.

Data restoration processor 27 restores original data DT from shared data BK0 with the small data size and shared data BK3 with the large data size using the data restoration process based on the algorithm of the same asymmetric sharing process as data sharing processor 12 (ST14) and transmits original data DT obtained through the restoration to data output controller 28.

Data output controller 28 performs and switches the output processes using original data DT received from data restoration processor 27 to data outputter 29 (for example, the display process on the display and the audio outputting process to the speaker) according to classification of original data DT. Specifically, data output controller 28 displays original data DT on the display, reproduces original data DT and outputs the audio from the speaker, or performs both of the displaying and the reproducing and outputting (ST15).

As described above, in delivery system 100 according to the present exemplary embodiment, data transmitter 10 shares original data DT to first data (shared data BK3 with the large size) and second data (shared data BK0 with the small size) with different sizes using the asymmetric secret sharing and encrypts shared data BK0 using the common key corresponding to the common key encryption scheme (for example, the AES). Data transmitter 10 transmits encrypted data ECD obtained by combining shared data BK3 and encrypted shared data BK2 to data receiver 20. Data receiver 20 receives encrypted data ECD transmitted from data transmitter 10 and divides encrypted data ECD into shared data BK3 and encrypted shared data BK2. Data receiver 20 decrypts encrypted shared data BK2 using the common key owned together with data transmitter 10 and restores original data DT using shared data BK3 and shared data BK0 obtained through the decryption to transmit original data DT.

Accordingly, delivery system 100 encrypts shared data BK0, obtained by sharing original data DT to be delivered from data transmitter 10 to data receiver 20 through the asymmetric secret sharing, according to the common key encryption scheme (for example, the AES). Therefore, the load of the encryption process can be reduced more than when entire original data DT is encrypted according to the common key encryption scheme (for example, the AES). Further, since delivery system 100 delivers encrypted data ECD in which shared data BK3 and encrypted shared data BK2 are combined rather than original data DT, it is possible to suppress deterioration in security of encrypted data ECD at the time of the delivery.

Data transmitter 10 encrypts the key (common key CK) for the encryption of the common key encryption scheme (for example, the AES) using the key (for example, public key PUK of data receiver 20) corresponding to data receiver 20 and combines shared data BK3, encrypted shared data BK2, and encrypted common key CK to generate encrypted data ECD. Accordingly, data transmitter 10 encrypts the common key for the AES encryption in accordance with the key (for example, public key PUK of data receiver 20) corresponding to data receiver 20. Therefore, even when encrypted data ECD is leaked during the delivery, encrypted data ECD can be prevented from being decrypted unless the key (for example, secret key PRK of data receiver 20) related to the key corresponding to data receiver 20.

Data transmitter 10 holds public key PUK of data receiver 20 as an example of the key corresponding to data receiver 20. Accordingly, data transmitter 10 can encrypt common key CK for the encryption of the common key encryption scheme (for example, the AES) using public key PUK of data receiver 20, the decryption of common key CK can be restricted to only data receiver 20 holding secret key PRK of data receiver 20. Thus, it is possible to suppress the deterioration in the security of common key CK.

Since data transmitter 10 uses exclusive OR when the asymmetric secret sharing is performed on original data DT and further uses the AES encryption as the common key encryption scheme, the processing load at the time of the asymmetric secret sharing can be reduced. Thus, it is possible to ensure the security of shared data BK2 included in encrypted data ECD.

Data receiver 20 generates public key PUK and secret key PRK of data receiver 20, holds secret key PRK, and transmits public key PUK to data transmitter 10. Accordingly, data transmitter 10 can hold public key PUK of data receiver 20 transmitted from data receiver 20, and thus can encrypt common key CK for the encryption of the common key encryption scheme (for example, the AES) using public key PUK of data receiver 20.

Various exemplary embodiments have been described above with reference to the drawings, but it is needless to say, the present disclosure is not limited to the examples. It should be apparent to those skilled in the art that various modification examples and correction examples can be made within the scope described in the claims, and it is construed that the modification examples and the correction examples, of course, belong to the technical scope of the present disclosure. The constituent elements in the above-described present exemplary embodiment may be combined in any manner within the scope of the present disclosure without departing from the gist of the present disclosure.

For example, in the above-described present exemplary embodiment, data sharing processor 12 generates the two pieces of shared data BK0 and BK3 with the different data sizes from original data DT through the asymmetric secret sharing process, but may generate three or more pieces of shared data. In this case, data encryption processor 14 performs the AES encryption on shared data of which a data size is not large among the three or more pieces of shared data. As in shared data BK3 according to the above-described present exemplary embodiment, the two remaining pieces of shared data may be included in encrypted data ECD without particularly performing an encryption process. This is because the confidentiality of each piece of shared data is improved through the asymmetric secret sharing process.

For example, in the above-described present exemplary embodiment, data encryption processor 14 performs the AES encryption on shared data BK0 with the small data size between two pieces of shared data BK0 and BK3, but may perform the AES encryption on shared data BK3 with the large data size. In this case, since the capacity of shared data subjected to the AES encryption further increases, the confidentiality of encrypted data ECD is further improved.

For example, in the above-described present exemplary embodiment, data receiver 20 transmits public key PUK of data receiver 20 to data transmitter 10 in advance before data transmitter 10 generates encrypted data ECD, as described above. However, the timing at which data receiver 20 transmits public key PUK is not limited to the timing before the generation of encrypted data ECD. For example, while data transmitter 10 generates encrypted data ECD or at a predetermined timing designated by the user, data receiver 20 may be requested to transmit public key PUK of data receiver 20 so that public key PUK is obtained. Accordingly, for example, when a valid period of public key PUK of data receiver 20 expires, data transmitter 10 can acquire recent public key PUK of data receiver 20 at a timing desired by the user. Thus, it is possible to suppress the deterioration in the security of encrypted data ECD.

In the above-described present exemplary embodiment, the delivery system has been described as an example, but may be used also for, for example, encryption of data in a PC. Specifically, when the user inputs a password into a PC, common key CK can be generated from the password, the same encryption process as that of data transmitter 10 can be performed on the data in the PC. When the data in the PC is used, the user can input the password to the PC, so that the same data restoration process as that of data receiver 20 can be realized. In this case, public key PUK is not necessary.

The present disclosure is useful in an encryption device, an encryption method, and a delivery system suppressing deterioration in security at the time of delivery of data while reducing a load of an encryption process for data to be delivered.

What is claimed is:

1. An encryption device comprising:
a sharer that shares data to first data and second data with different sizes using secret sharing;
a data encryptor that encrypts the second data with the size smaller than the first data using a key corresponding to a key encryption scheme;
a combiner that combines the first data and the second data encrypted by the data encryptor; and
a transmitter that transmits encrypted data combined by the combiner to an external device.

2. The encryption device according to claim 1, further comprising:
a key encryptor that encrypts the key using a key corresponding to the external device,
wherein the combiner combines the first data, the second data encrypted by the data encryptor, and the key encrypted by the key encryptor.

3. The encryption device according to claim 2, further comprising:
a key holder that holds the key corresponding to the external device,
wherein the key holder holds a public key of the external device as the key corresponding to the external device.

4. The encryption device according to claim 1,
wherein the sharer performs asymmetric secret sharing using exclusive OR, and
wherein the data encryptor performs advanced encryption standard (AES) as the key encryption scheme.

5. An encryption method in an encryption device, the method comprising:
sharing data to first data and second data with different sizes using secret sharing;
encrypting the second data with the size smaller than the first data using a key corresponding to a key encryption scheme;
combining the first data and the encrypted second data; and
transmitting combined encrypted data to an external device.

6. A delivery system in which an encryption device and a decryption device are connected,
wherein the encryption device includes
a sharer that shares first data and second data with different sizes using secret sharing,
a data encryptor that encrypts the second data with the size smaller than the first data using a key corresponding to a key encryption scheme,
a combiner that combines the first data and the second data encrypted by the data encryptor, and
a first transmitter that transmits encrypted data combined by the combiner to an decryption device, and
wherein the decryption device includes
a receiver that receives the encrypted data transmitted from the first transmitter,
a divider that divides the encrypted data into the first data and the second data encrypted by the data encryptor,
a data decryptor that decrypts the second data encrypted by the data encryptor using the key,
a restorer that restores the data using the first data and the second data decrypted by the data decryptor, and
an outputter that transmits the data restored by the restorer.

7. The delivery system according to claim 6,
wherein the decryption device further includes
a public key generator that generates a public key and a secret key of the decryption device,
a secret key holder that holds the secret key generated by the public key generator, and
a second transmitter that transits the public key generated by the public key generator to the encryption device, and
wherein the encryption device further includes a public key holder that holds the public key transmitted from the second transmitter.
